(19) United States
(12) Patent Application Publication
(10) Pub. No.: US 2013/0322499 A1
(43) Pub. Date: Dec. 5, 2013

(54) Single Transceiver Operation

(71) Applicant: Nabil Yousef Wasily, Foothill Ranch, CA (US)

(72) Inventor: Nabil Yousef Wasily, Foothill Ranch, CA (US)

(73) Assignee: NEWPORT MEDIA, INC., Lake Forest, CA (US)

(21) Appl. No.: 13/904,022

(22) Filed: May 29, 2013

Related U.S. Application Data
(60) Provisional application No. 61/652,675, filed on May 29, 2012.

(51) Int. Cl. H04W 88/06

(52) U.S. Cl. CPC H04W 88/06
USPC 375/219

(57) ABSTRACT

A system and method includes a pair of voltage-controlled oscillators (VCOs) that include a first VCO generating a first signal associated with data transmission of a first type of wireless data signal; and a second VCO generating a second signal associated with data transmission of a second type of wireless data signal, wherein the first type of wireless data signal uses a different carrier frequency than the second type of wireless data signal. The system further includes a multiplexer operatively connected to the pair of VCOs that selectively outputs the first signal or the second signal to generate a selectively outputted signal; and a mixer operatively connected to the switch that combines the selectively outputted signal with at least one additional signal and outputs a composite signal. The first type of wireless data signal includes a WiFi signal. The second type of wireless data signal includes a Bluetooth® signal.

### CROSS-REFERENCE TO RELATED APPLICATIONS

This application claims priority to U.S. Provisional Application Ser. No. 61/652,675 filed on May 29, 2012, the complete disclosure of which, in its entirety, is herein incorporated by reference.

### BACKGROUND

1. Technical Field

The embodiments herein generally relate to wireless technologies, and, more particularly, to WiFi and Bluetooth® technologies.

2. Description of the Related Art

WiFi and Bluetooth® wireless standards use the same carrier band (e.g., 2.4 GHz) to transfer and receive data packets. The conventional WiFi and Bluetooth® combination architecture is shown in FIG. 1. However, if a WiFi transceiver 40 and a Bluetooth® transceiver 42 are proximately coexisting, then they can interfere with one another. For example, if a WiFi transceiver 40 in user equipment (UE) is transferring data packets to a router, and a Bluetooth® transceiver 42 in the UE is transferring audio to a headset, if the two transceivers 40, 42 have no idea of the existence of the other corresponding transceiver, then they will interfere and destroy each other's data packets. Combination chips have both WiFi and Bluetooth® transceivers 40, 42 on the same chip die, however without avoiding data interference, there would be low throughput and dropped calls, etc. Moreover, previous solutions of permitting both WiFi and Bluetooth® transceivers 40, 42 to work together have resulted in increased chip sizes and costs. However, there remains a need for a single transceiver solution that avoids data interference and destruction of data packets due to the coexistence of both WiFi and Bluetooth® transceivers.

### SUMMARY

In view of the foregoing, an embodiment herein provides a system comprising a pair of voltage-controlled oscillators (VCOs), wherein the pair of VCOs comprise a first VCO generating a first signal associated with data transmission of a first type of wireless data signal; and a second VCO generating a second signal associated with data transmission of a second type of wireless data signal, wherein the first type of wireless data signal uses a different carrier frequency than the second type of wireless data signal. The system further comprises a switch operatively connected to the pair of VCOs that selectively outputs the first signal or the second signal to generate a selectively outputted signal; and a mixer operatively connected to the switch that combines the selectively outputted signal with at least one additional signal and outputs a composite signal. The first type of wireless data signal comprises a WiFi signal. The second type of wireless data signal comprises a Bluetooth® signal. The switch may comprise a multiplexer.

The pair of VCOs may be phase locked loop. The system may further comprise a first processor associated with the first type of wireless data signal, and a second processor associated with the second type of wireless data signal. The switch may receive switching instructions from the first processor and the second processor regarding when to switch between the first signal or the second signal for generating the selectively outputted signal. The system may further comprise duplicate registers that store the switching instructions. The pair of VCOs may be in parallel. The first processor and the second processor are on a same chip die.

Another embodiment provides a method of providing dual mode transceiver operation, the method comprising generating a pair of signals from a pair of VCOs, wherein the generating a pair of signals comprises generating a first signal associated with data transmission of a first type of wireless data signal from a first VCO of the pair of VCOs; and generating a second signal associated with data transmission of a second type of wireless data signal from a second VCO of the pair of VCOs, wherein the first type of wireless data signal uses a different carrier frequency than the second type of wireless data signal. The method further comprises selectively outputting the first signal or the second signal to generate a selectively outputted signal; combining the selectively outputted signal with at least one additional signal; and outputting a composite signal.

The first type of wireless data signal comprises a WiFi signal. The second type of wireless data signal comprises a Bluetooth® signal. The method may further comprise using a switch to selectively output the first signal or the second signal, wherein the switch may comprise a multiplexer. The pair of VCOs may be phase locked loop. The method may further comprise associating a first processor with the first type of wireless data signal; associating a second processor with the second type of wireless data signal, wherein the switch receives switching instructions from the first processor and the second processor regarding when to switch between the first signal or the second signal for generating the selectively outputted signal. The method may further comprise storing the switching instructions in duplicate registers. The method may further comprise arranging the pair of VCOs in parallel. The method may further comprise arranging the first processor and the second processor on a same chip die.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a block diagram of conventional WiFi and Bluetooth® transceivers on the same chip die;

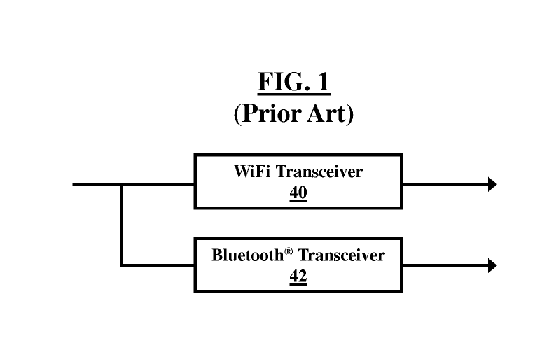

FIG. 2 illustrates a block diagram of an single transceiver allowing for combined WiFi and Bluetooth® operation on the same chip die according to an embodiment herein;

FIG. 3 illustrates a block diagram of a receiver according to an embodiment herein;

FIG. 4 illustrates a block diagram of a computer system according to an embodiment herein; and

FIG. 5 is a flow diagram illustrating a method according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

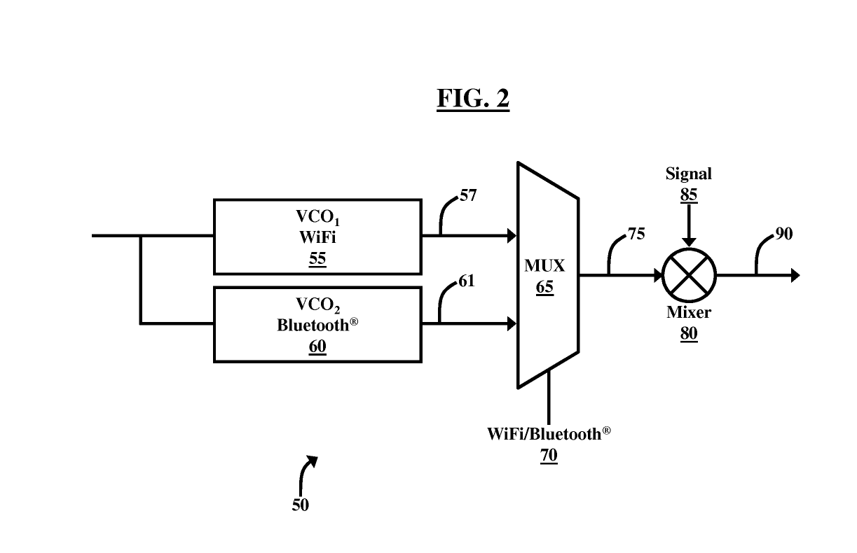

The embodiments herein provide a single transceiver functionality allowing for combined WiFi and Bluetooth® operation on the same chip die. Referring now to the drawings, and more particularly to FIGS. 2 through 5, where similar reference characters denote corresponding features consistently throughout the figures, there are shown preferred embodiments.

The embodiments herein share WiFi and Bluetooth® capabilities and time multiplex traffic. The embodiments herein share information from the Bluetooth® core to the WiFi core on when to switch transceiver modes. WiFi and Bluetooth® use different carrier frequencies, and the embodiments herein either use two voltage-controlled oscillators (VCOs) 55, 60 in parallel for fast switching, as shown in FIG. 2; or use a fast switching phase lock loop (PLL). The embodiments herein use duplicate registers to store the WiFi/Bluetooth® control information. In accordance with the system 50 shown in FIG. 2, each signal 57, 61 from the respective VCOs 55, 60 are fed into a multiplexer 65, which selects the appropriate signal based on the WiFi/Bluetooth® selector input 70. The output signal 75 is then fed to a mixer 80 into which an additional signal 85 is fed. Finally, the mixer 80 outputs one composite signal 90.

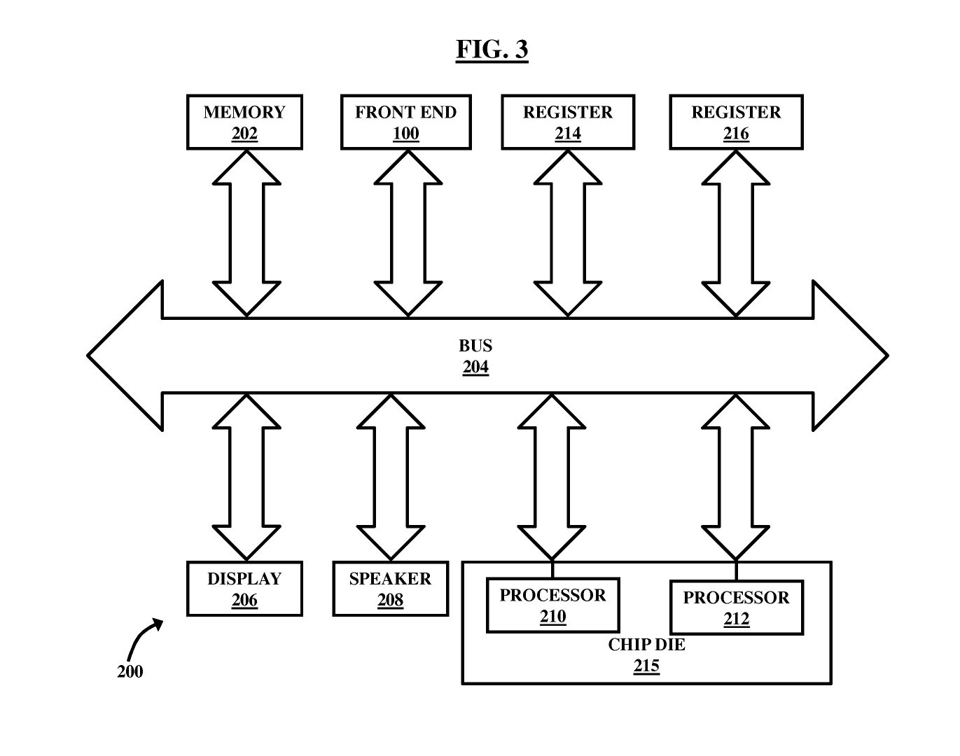

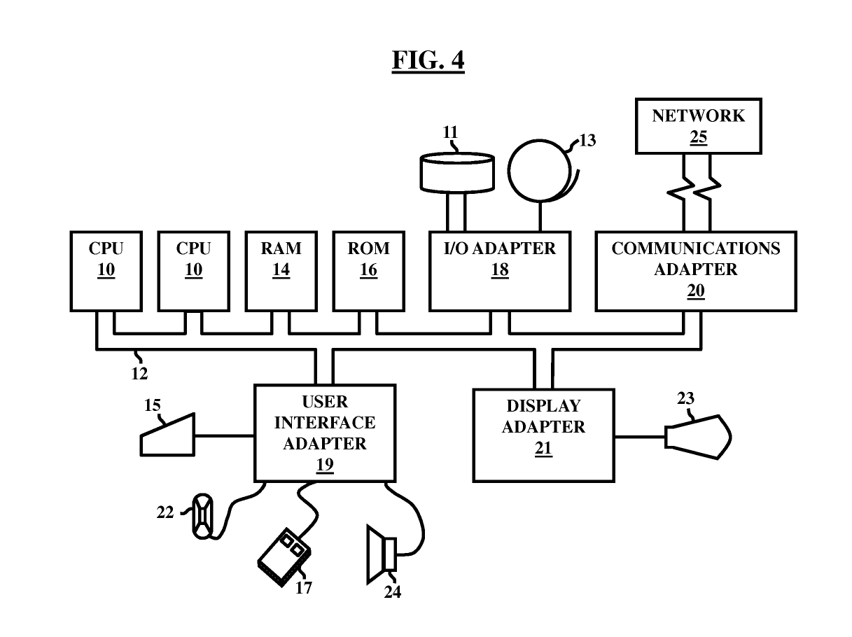

FIG. 3, with reference to FIG. 2, illustrates an exploded view of a UE 200 having a memory 202 comprising a computer set of instructions. The UE 200 further includes a bus 204, a display 206, a speaker 208, a pair of duplicate registers 214, 216, and processors 210, 212 capable of processing a set of instructions to perform any one or more of the methodologies herein, according to an embodiment herein. The processors 210, 212 may also enable analog content to be consumed in the form of output via one or more displays 206 or audio for output via speaker and/or earphones 208. The processors 210, 212, which are arranged on the same chip die 215, may also carry out the methods described herein and in accordance with the embodiments herein. The content may also be stored in the memory 202 for future processing or consumption. A user of the UE 200 may view this stored information on display 206. When the content is selected, the processors 210, 212 may pass information. The content may be passed among functions within the UE 200 using bus 204. The UE 200 may be operatively connected to a front end 100 for communication within a wireless communication network 25 (of FIG. 4).

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can include both hardware and software elements. The embodiments that are implemented in software include but are not limited to, firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments herein is depicted in FIG. 4, with reference to FIGS. 2 through 3. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

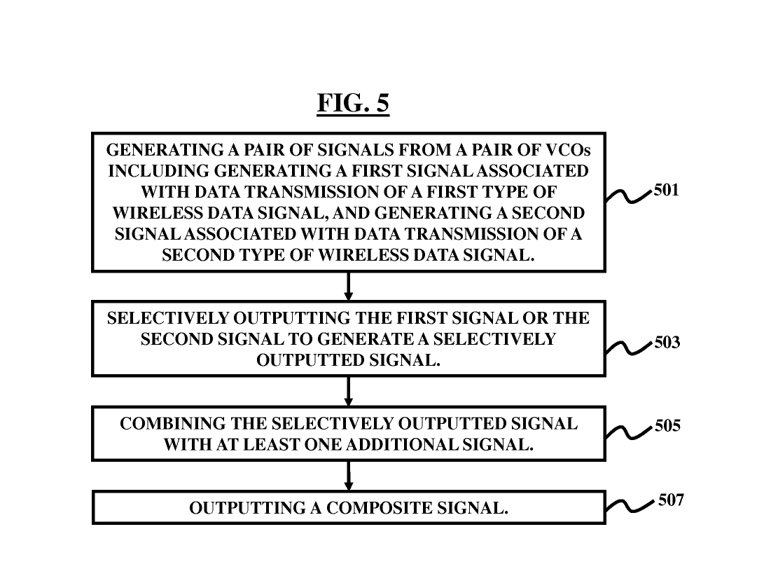

FIG. 5, with reference to FIGS. 2 through 4, is a flow diagram illustrating a method of providing dual mode transceiver operation according to an embodiment herein. The method comprises generating (501) a pair of signals from a pair of VCOs 55, 60, wherein the generating a pair of signals comprises generating a first signal 57 associated with data transmission of a first type of wireless data signal from a first VCO 55 of the pair of VCOs 55, 60; and generating a second signal 61 associated with data transmission of a second type of wireless data signal from a second VCO 60 of the pair of VCOs 55, 60, wherein the first type of wireless data signal uses a different carrier frequency than the second type of wireless data signal. The method further comprises selectively outputting (503) the first signal or the second signal to generate a selectively outputted signal 75; combining (505) the selectively outputted signal 75 with at least one additional signal 85; and outputting (507) a composite signal 90.

The first type of wireless data signal comprises a WiFi signal. The second type of wireless data signal comprises a Bluetooth® signal. The method may further comprise using a switch (e.g., multiplexer 65) to selectively output the first signal 57 or the second signal 61. The pair of VCOs 55, 60 may be phase locked loop. The method may further comprise associating a first processor 210 with the first type of wireless data signal; associating a second processor 212 with the second type of wireless data signal, wherein the switch 65 receives switching instructions from the first processor 210 and the second processor 212 regarding when to switch between the first signal 57 or the second signal 61 for generating the selectively outputted signal 75. The method may further comprise storing the switching instructions in duplicate registers 214, 216. The method may further comprise arranging the pair of VCOs 55, 60 in parallel. The method may further comprise arranging the first processor 210 and the second processor 212 on the same chip die 215.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A system comprising:
a pair of voltage-controlled oscillators (VCOs), wherein said pair of VCOs comprise:
a first VCO generating a first signal associated with data transmission of a first type of wireless data signal; and
a second VCO generating a second signal associated with data transmission of a second type of wireless data signal,
wherein said first type of wireless data signal uses a different carrier frequency than said second type of wireless data signal;
a switch operatively connected to said pair of VCOs that selectively outputs said first signal or said second signal to generate a selectively outputted signal; and
a mixer operatively connected to said switch that combines said selectively outputted signal with at least one additional signal and outputs a composite signal.

2. The system of claim 1, wherein said first type of wireless data signal comprises a WiFi signal.

3. The system of claim 1, wherein said second type of wireless data signal comprises a Bluetooth® signal.

4. The system of claim 1, wherein said switch comprises a multiplexer.

5. The system of claim 1, wherein said pair of VCOs are phase locked loop.

6. The system of claim 1, further comprising:
a first processor associated with said first type of wireless data signal; and
a second processor associated with said second type of wireless data signal.

7. The system of claim 6, wherein said switch receives switching instructions from said first processor and said second processor regarding when to switch between said first signal or said second signal for generating said selectively outputted signal.

8. The system of claim 7, further comprising duplicate registers that store said switching instructions.

9. The system of claim 1, wherein said pair of VCOs are in parallel.

10. The system of claim 6, wherein said first processor and said second processor are on a same chip die.

11. A method of providing dual mode transceiver operation, said method comprising:
generating a pair of signals from a pair of voltage-controlled oscillators (VCOs), wherein said generating a pair of signals comprises:
generating a first signal associated with data transmission of a first type of wireless data signal from a first VCO of said pair of VCOs; and
generating a second signal associated with data transmission of a second type of wireless data signal from a second VCO of said pair of VCOs,
wherein said first type of wireless data signal uses a different carrier frequency than said second type of wireless data signal;
selectively outputting said first signal or said second signal to generate a selectively outputted signal;
combining said selectively outputted signal with at least one additional signal; and
outputting a composite signal.

12. The method of claim 11 wherein said first type of wireless data signal comprises a WiFi signal.

13. The method of claim 11, wherein said second type of wireless data signal comprises a Bluetooth® signal.

14. The method of claim 11, further comprising using a switch to selectively output said first signal or said second signal.

15. The method of claim 14, wherein said switch comprises a multiplexer.

16. The method of claim 11, wherein said pair of VCOs are phase locked loop.

17. The method of claim 14, further comprising:
associating a first processor with said first type of wireless data signal; and
associating a second processor with said second type of wireless data signal,
wherein said switch receives switching instructions from said first processor and said second processor regarding when to switch between said first signal or said second signal for generating said selectively outputted signal.

18. The method of claim 17, further comprising storing said switching instructions in duplicate registers.

19. The method of claim 11, further comprising arranging said pair of VCOs in parallel.

20. The method of claim 17, further comprising arranging said first processor and said second processor on a same chip die.
